(19) United States
(12) Patent Application Publication
(10) Pub. No.: US 2025/0153043 A1
(43) Pub. Date: May 15, 2025

(54) HYBRID REAL TIME DATABASE SYSTEM

(71) Applicants: Benoit Gagnon, Montreal (CA); David Vogel, Bellevue, WA (US); Michael Canfield, Bellevue, WA (US); Starly Solon, Montreal (CA); Ming Zhu, El Sobrante, CA (US)

(72) Inventors: Benoit Gagnon, Montreal (CA); David Vogel, Bellevue, WA (US); Michael Canfield, Bellevue, WA (US); Starly Solon, Montreal (CA); Ming Zhu, El Sobrante, CA (US)

(21) Appl. No.: 18/389,529

(22) Filed: Nov. 14, 2023

(51) Int. Cl. A63F 13/352; A63F 13/792

(52) U.S. Cl. CPC A63F 13/352; A63F 13/792; A63F 2300/513; A63F 2300/5513

(57) ABSTRACT

System and method including a database (DB) engine configured to access a DB, the DB engine and the DB configured based on a data locality configuration of a plurality of data locality configurations, the data locality configuration being associated with a first server. The DB engine is configured to process access requests and be inactive outside of processing the access requests. The system includes a data interface configured to receive access requests associated with the DB and retrieve results of the access requests. The system includes a software module configured to download a first DB version from remote storage to local storage, and enable uploading a local second DB version to the remote storage. Uploading the second DB version to remote storage can comprise comparing a generation ID for a downloaded DB version with a most recent generation ID of a most recent DB version stored at the remote storage.

### TECHNICAL FIELD

The disclosed subject matter relates generally to the technical field of databases and in one particular example, to a high-performance, low-latency hybrid database solution for game servers.

### BACKGROUND

Persistent world experiences and evolving, long-lasting and immersive virtual spaces are highly popular. Examples include metaverse experiences, massively multiplayer online games (MMOs), or persistent multiplayer worlds. Enabling such experiences requires improvements in available data storage and update solutions, such as DB technologies.

### BRIEF DESCRIPTION OF THE SEVERAL VIEWS OF THE DRAWINGS

Some embodiments are illustrated by way of example and not limitation in the figures of the accompanying drawings.

FIG. 1 is a network diagram illustrating a system within which various example embodiments may be deployed.

FIG. 2 is a diagrammatic representation of a hybrid real-time database system (HRTDS), according to some examples.

FIG. 3 is a diagrammatic representation of server life cycles, according to some examples.

FIG. 4 is a diagrammatic representation of data locality configurations for HRTDS, according to some examples.

FIG. 5 is a diagrammatic representation of database (DB) download and DB upload data flows, according to some examples.

FIG. 6 illustrates an example method, as implemented by HRTDS.

FIG. 7 is a block diagram illustrating an example of a software architecture that may be installed on a machine, according to some examples.

FIG. 8 is a block diagram illustrating components of a machine, according to some examples, able to read instructions from a machine-readable medium (e.g., a machine-readable storage medium) and perform any one or more of the methodologies discussed herein.

### DETAILED DESCRIPTION

Persistent world experiences and evolving, long-lasting and immersive virtual spaces are highly popular. Examples include metaverse experiences, massively multiplayer online games (MMOs), or persistent multiplayer worlds. Such experiences are enabled by data storage and update solutions, such as DB technologies. In the disclosure herein, a DB refers to a store of data, such as a loose collection of files on disk, a key value store, a document store, a full relational DB system, and other data store types. Such DB technologies benefit from considering the challenges and opportunities specific to persistent world experiences.

For example, popular games such as Minecraft®, V Rising®, or Valheim® offer persistent worlds (e.g., a Minecraft world) that exist beyond a single play session or beyond the lifetime of a game server. World data or world state (e.g., blocks in Minecraft, buildings in SimCity®, factories in Factorio®) can be input/output (I/O) intensive, grow to several gigabytes, or need to be accessible in near real-time, which is difficult to support with existing cloud-based data storage solutions. A game server may require minimal latency for data access and/or data operations in order to provide acceptable performance. Furthermore, an end user can require the ability to version and restore an entire world to a consistent point in time (e.g., transaction point), allowing a game server to repeatedly load and unload world state information at runtime. End users can also benefit from having persistent interactions with online experiences, for example in the form of local interactions with a local game server, punctuated by periodically saving the state of the interaction to local and/or remote storage, such as cloud storage. To improve flexibility and robustness, data storage and update solutions should function with or without cloud connectivity.

World state for persistent world experiences also presents specific opportunities. For example, the game server alone, rather than the players, interacts with the world state; world state data may not need not to be online at all times, but only when a game server is actively attached; data processing outside of a game server context can be satisfied with read-only access (among other opportunities).

Current DB solutions are not well-suited to addressing the variety of challenges and taking advantage of the opportunities described above with respect to persistent world experiences. For example, current DB solutions typically offer either local or remote storage options. Furthermore, remote storage options usually involve a primary cloud backend mechanism. However, persistent world experience use cases can benefit from a mix of local storage and remote storage (e.g, cloud storage) options. Additionally, differences in use cases map to a large variety of development needs and require a flexible cloud backup strategy, rather than a single cloud backend mechanism. Current DB solutions typically require a stateful DB runtime in order to access data or execute queries. However, different applications, such as those enabling persistent world experiences, have different requirements for data access or different query or computation requirements, which obviate the need to maintain a stateful DB runtime for an extended period of time. In addition to technical requirements, the different applications can have different cost constraints more easily met in the absence of an extended and therefore costly stateful DB runtime. Furthermore, many current DB solutions are centralized and require explicit sharding by developers in multi-server data persistence scenarios, which can lead to increased DB schema complexity, increased DB size and runtime overheads.

Example embodiments disclosed herein refer to a hybrid real-time database system (HRTDS) that enables the use of DBs co-located with a host server (e.g., a game server), where the DBs can be persisted to and downloaded from remote storage (e.g., cloud storage). HRTDS provides a high throughput, low latency DB solution that can be seen as an preferable alternative to a game save format. Many developers are likely to be comfortable with a DB solution, and will likely benefit from interacting with game state data by means of reading and writing structured data. In some examples, each HRTDS DB can be seen as a single file, with file semantics.

In some examples, HRTDS DBs are co-located with one or more server applications on a host server (e.g., a game server), and/or are synchronized or backed up to remote storage, such as cloud storage. HRTDS is thus a DB engine that can be utilized within the co-located server application process for increased speed, and/or which ensures robustness by the use of remote storage (e.g., cloud storage.) In some examples, HRTDS DB files are by design bound with server context, so no explicit sharding by developers is required—HRTDS provides a flexible, automatic sharding mechanism based on server context. The lack of explicit sharding results in reduced DB schema complexity, DB size and runtime overheads.

In some examples, HRTDS provides a lightweight remote storage access mode in the form of a lightweight remote storage backend. DB files stored remotely can be accessed in a static fashion, that is without requiring a stateful DB runtime. In some examples, HRTDS enables multiple cloud backup strategies: manual (backup performed upon request from developers, and/or controlled by developers), atomic (small incremental changes being automatically synced up to the cloud), or periodic (full snapshots are automatically backed up at specified intervals).

In some examples, HRTDS provides a flexible and versatile data interface, supporting both SQL queries and No-SQL queries. The data interface can be used to store and retrieve arbitrarily complex and diverse data types, such as for example avatars, assets, events and more.

In some examples, the HRTDS DB system supports distributed access through publisher-subscriber (pub-sub) change notifications. HRTDS uses a fan-out pattern to publish DB changes for a DB on a host server, where the changes can be subscribed to by non-host servers. One or more non-host servers can access the DB in read-only mode. The read-only access ensures no lock mechanism is needed, and ensures the deterministic data authority of a single data owner (e.g., the local host server).

In some examples, HRTDS includes a DB engine configured to access a DB, the DB engine and the DB being configured based on one or multiple data locality configurations. In some examples, the data locality configuration is associated with a first server, and specifies that the DB engine and the DB are embedded within a server process of the first server. In some examples, the data locality configuration associated with the first server specifies that the DB engine and the DB are part of a process separate from the server process of the first server.

In some examples, HRTDS includes a data interface configured to receive access requests associated with the DB and retrieve results of the respective access requests. In some examples, the HRTDS data interface is configured to use one of a (key, value) data model, a document model or a relational model. The DB engine runs while access requests are being processed. The DB engine can become and/or remain inactive outside of processing the access requests.

In some examples, HRTDS includes a software module, such as a software development kit (SDK), enabled to download a first version of the DB from remote storage to local storage associated with the first server. HRTDS can use the software module to enable uploading a second version of the DB from the local storage to the remote storage. In some examples, the access requests comprise one of at least a read access request or a write access request. The data interface is configured to provide, to the first server, read access to the DB and/or write access to the DB. The data interface is configured to provide, to a second server, read access to the DB, and disallow, with respect to the second server, write access to the DB. In some examples, the second server is a subscriber server configured to received change notifications corresponding to changes to the DB from the first server.

In some examples, HRTDS combines low-latency local database access embedded directly within game server processes with remote storage and access from a cloud backend. Databases are synchronized bidirectionally, uploaded to the cloud for backup and downloaded locally for performance-critical access during gameplay sessions. By embedding databases locally on game servers, data access latencies are minimized. At the same time, remote cloud storage ensures data persistence, accessibility when a local server is offline, and allows distributed multi-server architectures through change notification messaging. The HRTDS handles database sharding automatically based on server context, reducing complexity for developers. Flexible data storage and retrieval is enabled through data access interfaces, such as SQL and NoSQL data access interfaces. Thus the HRTDS provides an optimized database solution for persistent world environments by leveraging a hybrid of local and remote storage options.

In example embodiments, a database (DB) engine is configured to access a DB. The DB engine and the DB are configured based on a data locality configuration of a plurality of data locality configurations. The data locality configuration is associated with a first server. The DB engine is configured to process access requests and be inactive outside of processing the access requests. A data interface is configured to receive access requests associated with the DB and retrieve results of the access requests. A software development kit (SDK) is configured to enable downloading of a first version of the DB from remote storage to local storage associated with the first server and enable uploading of a second version of the DB from the local storage to the remote storage.

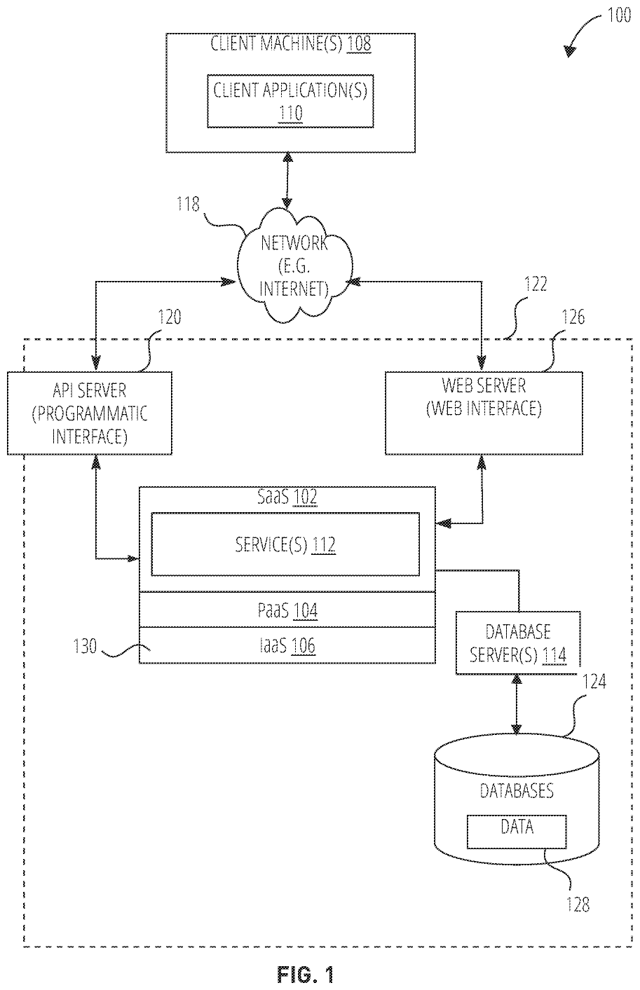

FIG. 1 is a network diagram depicting a system 100 within which various example embodiments described herein may be deployed. A networked system 122 in the example form of a cloud computing service, such as Microsoft Azure or other cloud service, provides server-side functionality, via a network 118 (e.g., the Internet or Wide Area Network (WAN)) to one or more endpoints (e.g., client machine(s) 108). FIG. 1 illustrates client application(s) 110 on the client machine(s) 108. Examples of client application(s) 110 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, contact center applications, digital content creation applications (e.g., game development applications) or game applications. Each of the client application(s) 110 may include a software application module (e.g., a plug-in, add-in, or macro) that adds a specific service or feature to the application.

An API server 120 and a web server 126 are coupled to, and provide programmatic and web interfaces respectively to, one or more software services, which may be hosted on a software-as-a-service (SaaS) layer or platform 102. The SaaS platform may be part of a service-oriented architecture, being stacked upon a platform-as-a-service (PaaS) layer 104 which, may be, in turn, stacked upon an infrastructure-as-a-service (IaaS) layer 106 (e.g., in accordance with standards defined by the National Institute of Standards and Technology (NIST)).

While the applications (e.g., service(s)) 112 are shown in FIG. 1 to form part of the networked system 122, in alternative embodiments, the applications 112 may form part of a service that is separate and distinct from the networked system 122.

Further, while the system 100 shown in FIG. 1 employs a cloud-based architecture, various embodiments are, of course, not limited to such an architecture, and could equally well find application in a client-server, distributed, or peer-to-peer system, for example. The various server services or applications 112 could also be implemented as standalone software programs. Additionally, although FIG. 1 depicts machine(s) 108 as being coupled to a single networked system 122, it will be readily apparent to one skilled in the art that client machine(s) 108, as well as client application(s) 110 (such as game applications), may be coupled to multiple networked systems, such as payment applications associated with multiple payment processors or acquiring banks (e.g., PayPal, Visa, MasterCard, and American Express).

Web applications executing on the client machine(s) 108 may access the various applications 112 via the web interface supported by the web server 126. Similarly, native applications executing on the client machine(s) 108 may access the various services and functions provided by the applications 112 via the programmatic interface provided by the API server 120. For example, the third-party applications may, utilizing information retrieved from the networked system 122, support one or more features or functions on a website hosted by the third party. The third-party website may, for example, provide one or more promotional, marketplace or payment functions that are integrated into or supported by relevant applications of the networked system 122.

The server applications may be hosted on dedicated or shared server machines (not shown) that are communicatively coupled to enable communications between server machines. The server applications 112 themselves are communicatively coupled (e.g., via appropriate interfaces) to each other and to various data sources, so as to allow information to be passed between the server applications 112 and so as to allow the server applications 112 to share and access common data. The server applications 112 may furthermore access one or more databases 124 via the database server(s) 114. In example embodiments, various data items are stored in the databases 124, such as the system's data items 128. In example embodiments, the system's data items may be any of the data items described herein.

Navigation of the networked system 122 may be facilitated by one or more navigation applications. For example, a search application (as an example of a navigation application) may enable keyword searches of data items included in the one or more databases 124 associated with the networked system 122. A client application may allow users to access the system's data 128 (e.g., via one or more client applications). Various other navigation applications may be provided to supplement the search and browsing applications.

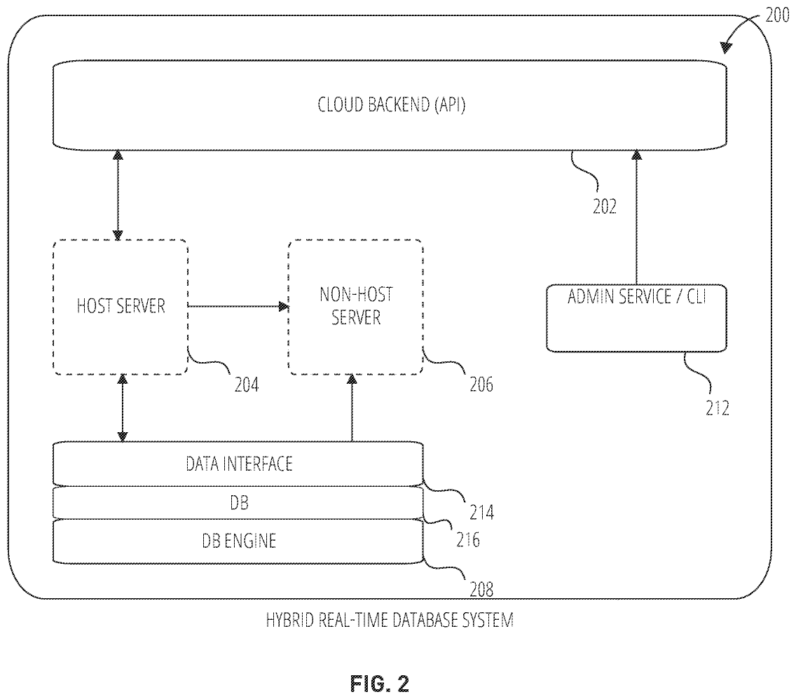

FIG. 2 is a diagrammatic representation of a hybrid real-time database system (HRTDS) 200, according to some examples. HRTDS 200 includes a DB engine 208, a DB 216, a data interface 214, and a cloud backend 202, among other components. In some examples, the DB 216 and/or DB engine 208 are co-located with a host server 204 (e.g., a game server), which has advantages such as low latency, predictable and stable performance, maximum bandwidth, avoiding the need to rely on data center network fabric, secure data access via the use of a local file system, reduced costs (e.g., compute is already paid for, costs incurred are due to need to cover additional durable storage), ability to locally edit downloaded data and/or upload data to durable storage, feasibility of shutting down and/or restarting a host server to download modified data, and other advantages. Furthermore, durable storage need not be highly performant, as reads/writes to long term storage (e.g., using the cloud backend 202, available via an API) can be sequential and infrequent. In some examples, a non-host server 206 can interact with the host server 204, DB engine 208, or DB 216. In some examples, an admin service 212 can interact with the cloud backend 202.

DB 216 can store a wide variety of data. Given the example of a game server, DB 216 can store data for a world or a realm (e.g., an instance of a world), such as data relating to characters or players that interact with that world, game states, scene graphs, and other data. In some examples, host server 204 owns the live DB runtime, and can perform read or write operations with respect to persistent data stored in DB 216, via a data interface 214. Data interface 214 can support SQL and/or No-SQL queries, as further described below. The read or write operations performed by the host server 204 are low-latency operations (e.g., ˜0 ms latency reads and writes). HRTDS 200 allows persistence data, such as game persistence data, to be handled within a server process such as a game server process. As mentioned, game persistence data can include world-bound and player-bound states, reducing the need for additional backend services such as services for storing player state, or central services outside of the server process, thereby mitigating the complexity of distributed microservices. In some examples, HRTDS 200 can use and/or extend DB or object store technologies such as SQLite, LevelDB, RocksDB, Realm, LiteDB, ObjectBox, LMDB, CouchBase Lite, UNQLite, and so forth. For example, DB 216 can be a SQLite DB.

In some examples, HRTDS 200 is optimized for single server access. HRTDS 200 can forgo support for concurrent connections. In some examples, a single writer thread and/or any number of reader threads are allowed. Read transactions can be performed continuously in the background, keeping a point-in-time view of the data. The constraint of the single writer thread is appropriate in the context of a host server 204 corresponding to a game server (e.g., given the “tick” loop of a game server and/or the single scripting thread where most read-and-write operations usually happen). In some examples, a tick is a logical window that can be used by a host server 204 (e.g., a game server) to bound its transactions. In some examples, HRTDS 200 can support concurrent connections.

If data is accessed (e.g., DB 216 is read from, or written to, by the host server 204), the DB engine 208 is started, or running, on host server 204. If data is not accessed, DB engine 208 can be dormant or stopped, saving resources and reducing costs. Host server 204 can access static, raw data snapshots of DB 216 via the cloud backend 202. In some examples, accessing raw data snapshots available in cloud storage includes instantiating a DB runtime (e.g., via the DB engine 208) on host server 204 for the duration of the read data operation. Responsive to (or upon) the data operation being performed and/or a result being obtained, the DB runtime can be discarded by the host server 204.

In some examples, HRTDS 200 supports distributed access to DB 216 through pub-sub change notifications and/or allowing multiple servers to access the same DB in read-only mode. For example, HRTDS 200 can use a fan-out pattern to publish changes to a DB that can be subscribed by non-host servers: the host server 204, owning the live DB runtime, sends out updates on changes to the DB 216 to subscribing non-host servers such as non-host server 206. Non-host server 206 has read-only access to the DB 216, where the read-only access ensures that no lock mechanism is needed and confirms the deterministic data authority of a single data owner, host server 204. Non-host server 206 can perform low-latency read operations with respect to DB 216 (e.g., ˜0 ms latency reads).

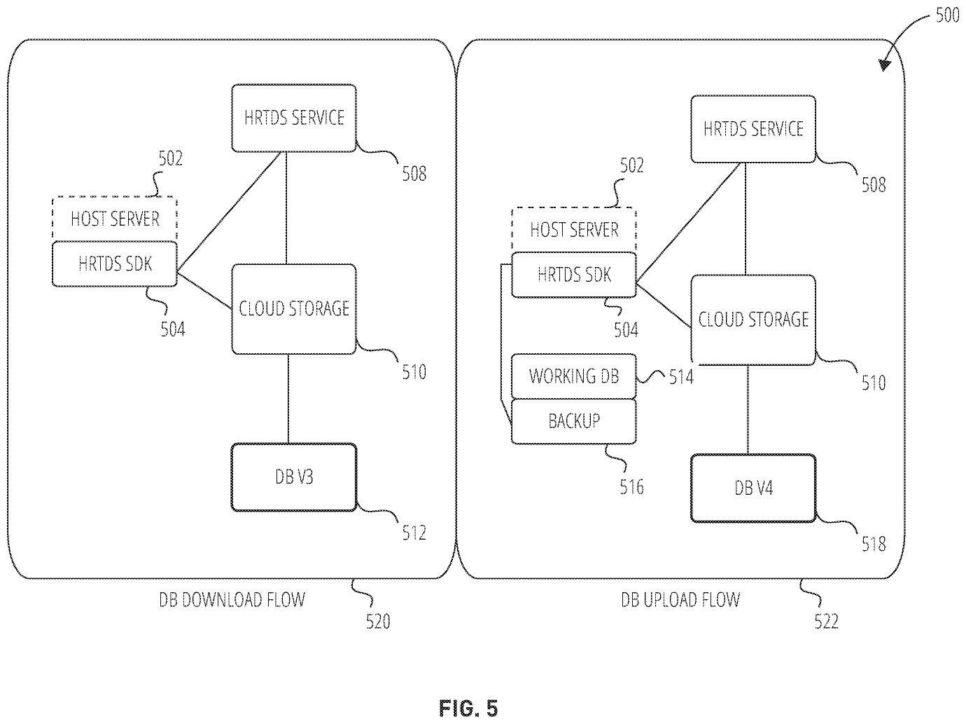

Snapshots of DB 216 can be generated according to a predetermined schedule (e.g., at set intervals), and/or triggered by lifecycle events of the host server 204. Such snapshots can be uploaded or persisted to cloud storage, via the cloud backend 202 (e.g., using a REST API). In some examples, snapshots can be full snapshots, while in others, atomic changes to data in DB 216 can trigger a synchronization or back-up process with respect to the cloud backend 202. In some examples, an admin service and/or command-line interface (CLI) 212 can communicate with the cloud backend 202 to perform DB maintenance tasks such as rollbacks, repairs, merges, cleanups, and so forth. Cloud storage solutions used for durable storage of HRTDS 200 data can include Google Cloud Storage (GCS), Amazon Simple Storage Service (S3), Azure Storage, and other solutions. Durability is further enhanced by the DB versioning process, as seen at least in FIG. 5.

### HRTDS DB Management Operations

DBs in HRTDS 200 are associated with a given project (e.g., denoted by a project ID), and/or with a given environment (e.g., denoted by an environment ID). In some examples, DB 216 has a unique identifier (ID) as seen in example metadata for a DB instance in Table 3. A DB ID is a unique, immutable, per-project, per-environment identifier generated automatically when a DB instance, such as DB 216, is created.

In some examples, a HRTDS service 508 (e.g., a service API) and/or a HRTDS software development kit (SDK) 504 enable operations such as DB creation, DB deletion, DB uploading/downloading, and other operations (see at least Table 1 and Table 2). Such services and/or APIs can use the DB ID to interact with DB 216 and track references to it. In addition to the DB ID, HRTDS service API and/or SDK operations can provide project information (e.g., project ID) and/or environment information (e.g., environment ID) either explicitly or as a part of the SDK context. DB IDs provide HRTDS DBs with a logical identity independent from their physical location, and/or abstract away networking operations involving the remote or central storage (such as cloud storage). Host server 204 can address a DB using a DB ID (in the host's local execution environment). Host server 204 does not need to explicitly specify data fetching and preparation operations, or explicitly address authentication, encryption, latency or serialization concerns, or network I/O implications. The cloud backend 202 can also track a DB using the DB ID (e.g., for loading or updating the data). Furthermore, a HRTDS DB obeys standard file system semantics, allowing developers on developer workstations to use a simplified development workflow.

Tables 1 and 2 illustrate example HRTDS service API and/or SDK operations for DB creation, DB deletion, DB uploading, DB downloading, and other operations.

TABLE 1
Example HRTDS Service API operations.

| Endpoint | Method | Description |
|---|---|---|
| /databases | GET | Lists the DBs for a given project ID and |
| | | environment ID. |
| /databases | POST | Creates a DB. Returns a corresponding DB ID |
| | | with a signed URL pointing to a first upload |
| | | location. |
| /databases/{id} | GET | Retrieves the signed URL pointing to the |
| | | latest DB version. Optionally mark the DB as |
| | | “in use.” Optionally, use a version ID query |
| | | parameter to enable a download of a non- |
| | | current version of the DB. |
| /databases/{id} | POST | Starts uploading new DB version. Retrieves |
| | | the signed URL of upload location. |
| | | Optionally remove “in use” marker associated |
| | | with the DB. |
| /databases/{id} | DELETE | Delete DB with given ID. Delete DB versions |
| | | based on DB ID. |
| /databases/{id}/versions | GET | Show DB versions based on DB ID. |
| /databases/{id}/versions/{id} | DELETE | Delete a version based on a version ID for a |
| | | given DB ID. |
| /databases/{id}/live-version | POST | Replace the live version for a DB (based on a |
| | | DB ID) with a different existing version, |
| | | creating a new DB version. |

TABLE 2
Example HRTDS SDK DB management operations.

| Operation | Description |
|---|---|
| CreateDBAsync(Location) | Creates a new DB in a given storage location. Returns |
| | a DB collection. Location can be “Local” or |
| | “Remote” (“Remote” corresponding to a cloud |
| | storage option). |
| DownloadDBAsync(dbID) | Downloads the remote DB with the given ID to the |
| | local machine's temporary storage. |
| UploadDBAsync(IDBConnection) | Uploads the remote DB with a corresponding ID |
| | and/or connection from the local machine to remote |
| | storage. |
| OpenLocalDB(dbID) | Creates a connection to a locally stored DB with the |
| | specified DB ID. |
| CopyDBAsync(Source, Location) | Copies a given source DB and creates a new DB in |
| | the specified location. Enables the copying of a |
| | “Remote” DB for further local development. Enables |
| | the copying of a “Local” working DB to remote |
| | storage (e.g., a cloud location). |

Table 3 illustrates example attributes or metadata for DB 216. DB 216 is associated with a DB ID. DB 216 is associated with a Location field, whose example values include “Local” or “Remote”. DB 216 is associated with a FilePath corresponding to the location of the DB instance on a working machine such as the host server 204. DB attributes include a version field (corresponding to a version of the data model schema), and/or a bucket field (corresponding to a bucket in which the DB is stored). In some examples, a tenant corresponds to a combination ofSa project ID and environment ID. Each tenant can have its own bucket set. Furthermore, a client ofithe HRTDS 200 (e.g., a host server) can choose a region in which the data should be stored, and HRTDS 200 can create a bucket for the chosen region In some examples, buckets are not shared between tenants, in order to allow for accurate usage metering and attribution (storage, billable API operations) by tagging a specific bucket. In some examples, a bucket name and/or ID is automatically determined by hashing a string including a project ID and/or an environment ID. This bucket name generation method obviates the need to store the bucket name separately.

TABLE 3
Example Metadata of a HRTDS DB.

| Attribute | Value Format | Description |
|---|---|---|
| ID | String or UUID | Immutable, per-project, per-environment unique |
| | | identifier that is automatically generated when a DB |
| | | is created. |
| Version | Integer | A version of the data model schema, used to detect |
| | | if the model needs to be upgraded. |
| Location | StorageLocation | DB location. Values = {“Local,” “Remote,” etc.} |
| FilePath | String | File path indicating DB location on working |
| | | machine (e.g, host server). |
| Bucket | String | Bucket in which the DB is stored. |

In some examples, DB instances keep track of a region in which they are stored (e.g., GCS buckets are region locked). Clients of HRTDS 200 have the option of choosing from a set of supported regions in which their data should reside, for example to obtain better throughput when initially downloading a DB (e.g., a DB 216), or when backing it up. A bucket name and/or ID can be automatically determined by appending the region to a string hashed to compute the bucket name, where the string includes a project ID and/or an environment ID). For example, the string can be “hrtd.{projectID}.{environmentID}.{region}.” A hash function (e.g., sha-256, sha-224, or other hash functions) can be used to hash the string to obtain the bucket name and/or ID.

In some examples, HRTDS 200 uses the following data design for metadata associated with DB instances (e.g., a Collection/Document data design):
hrtd.projects.{projectID}.environments.{environmentD}.metadata.{dbID}.

One or more of the data design fields {projectID}, {environmentID}, and {dbID} are documents. One or more of these documents can be empty documents (without fields). In some examples, HRTDS 200 stores a bucket name by adding a field bucketName to the environment document. The field bucketName can also be converted to a map of region to bucket, for example to accommodate multiple regions.

In some examples, HRTDS 200 uses a data design that includes a Bucket collection that holds Bucket documents including Bucket metadata. In some examples, a region field can also be added to support multiple regions. An example such data design is:
hrtd.projects{projectID}.environments.{environmentID}.buckets.{bucket},
where {bucket} corresponds to a document.

As seen in Table 4 below, a bucket document can store data such as Bucket (e.g., name or ID), Region, Version, among other types of data. The key for a Bucket document can be an auto-generated universally unique identifier (UUID), or the region in which the bucket is to be stored. Using an UUID as the key can be useful if the document is to be used for purposes other than indicating the region. In some examples, the key for the Bucket document can be the region, in which case the Bucket document can be retrieved and a list of buckets can be parsed.

TABLE 4
Example Metadata for Buckets and/or Regions.

| Attribute | Value Format | Description |
|---|---|---|
| Region | String (or | A region's name or identifier. |
| | UUID) | |
| Version | Integer | A version of the data model schema, used for |
| | | detecting if the model needs to be upgraded or not. |
| Bucket | String (or | A bucket name and/or bucket ID to which the region |
| | UUID) | is mapped (e.g., for a project ID and environment ID). |
| | | Value can be a UUID. |

### HRTDS Data Models

Developers can represent world state using one or more data models including a relational model (e.g., accessing tables and/or inter-linked columns), a key-value model, or a document model, among other models. In some examples, HRTDS 200 enables the data interface 214 to support any of the previously listed data models. For example, the DB engine 208 and/or DB 216 can provide relational DB functionality, and the data interface 214 can be used to issue SQL queries. In some examples, DB engine 208 and/or DB 216 can provide the functionality of a key-value store, or of a document store, and the data interface 214 can support queries or access requests based on one or more of these models. The use of the DB engine 208 and/or DB 216 as a document store and/or key-value store can discourage the use of the filesystem as a DB, especially when records are small. File-based approaches can be beneficial during development time, for example, to integrate with version control and to work collaboratively. However, they may impact performance if used at runtime. Thus, using the DB engine 208 and/or DB 216 as a key-value store and/or a document store can improve runtime performance.

Key-value Storage and/or Data Model. DB engine 208 and/or DB 216 can function as key-value storage. In this case, the data interface 214 supports a key-value query model, where the value can be an arbitrary byte stream. Example use cases for such a data model and respective storage include attachment storage (e.g., audio, images, geometry) with no natural object mapping, or entity-component system persistence (e.g., Unity ECS/DOTS). In some examples, the key-value data model offered by HRTDS 200 includes a category field, which allows users to categorize the stored data, and/or allows for optimization to occur on specific queries. The primary key for the key-value model can be (category, key), enabling the system to use non-unique “key” field values as long as the combination (category, key) of a category and a key is unique.

Table 5 illustrates examples of queries and relevant data operations supported by the HRTDS 200, using for example a (key, value) data model.

TABLE 5
Data operations supported by HRTDS.

| Operation | Description |
|---|---|
| Open( ) | Initializes a DB for first use and open a connection. |
| Close( ) | Close the connection to the DB. |
| Get(key[, category]) | Retrieves the raw bytes representing the data stored at |
| | the provided key in the optionally specified category. |
| GetString(key[, category]) | Retrieves a string representation of the data stored at the |
| | provided key in the optionally specified category. |
| Put(key, value[, category]) | Write data in the form of raw bytes at the provided key |
| | in the optionally specified category. |
| PutString(key, value[, | Write data as a string at the provided key in the |
| category ]) | optionally specified category. |
| Delete(key[, category]) | Delete data at the provided key in the optionally |
| | specified category. |
| ListKeys([category]) | Get the list of keys in the DB. Can specify an optional |
| | category to only retrieve the keys within that category. |
| DeleteAllDatabaseContents( ) | Delete all data in the DB. |

Document Storage and/or Data Model. In some examples, the DB engine 208 and/or DB 216 function as a document store. Data interface 214 supports queries or access requests based on a document data model. The document store can be a NoSQL DB (e.g., such as MongoDB). The document store offered by HRTDS 200 has one or more of the following characteristics: a) enables storage of arbitrary documents (e.g., JSON objects), b) enables mapping objects (e.g., any serializable object) to records, c) forgoes any requirement for documents to share a common schema; d) forgoes any requirement to pre-define a schema. In some examples, HRTDS 200 can handle references between objects in conjunction with mapping objects to records (e.g., HRTDS 200 would function as an object DB). In some examples, HRTDS 200 can forgo handling references between objects.

In some examples, HRTDS 200's document storage solution indexes documents based on a primary key (e.g., such as a document ID). HRTDS 200 can also offer support for secondary indices that enable querying on fields other than the primary key. Documents that do not align with the index definition are considered to have a null value for one or more fields, obviating the need for a strict schema. In some examples, HRTDS 200 enables querying by document type, for example by using document type-specific tables and/or special columns. Thus, HRTDS 200 may not need to explicitly define a separate “type” field or secondary index. In some examples, querying by document type can be accomplished by defining a separate “type” field and/or a secondary index.

In some examples, HRTDS 200's document store solution can support the following common access patterns:
a) Fetch-by-ID: a host server (e.g., host server 204) retrieves the ID of documents (e.g., player IDs).
b) Fetch-All: all documents of a particular document type are retrieved and/or iterated upon.
c) Reference-Following: given a document D containing primary keys of other documents, the primary keys are retrieved (e.g., by the host server 204) and used to retrieve more documents from storage. The process can further continue based on additional primary keys in the additional retrieved documents.
d) Dynamic: documents are loaded, modified and written back based on contextual filters. For example, in the case of the host server 204 being a game server and players interacting with the world, such contextual filters may include a grid position.

In some examples, documents are stored as a “Blob” or as “Text,” without being separated into columns, an operation that would impose a schema. When a document is retrieved and/or read from a key-value API (e.g., as supported by the data interface 214), a document's serialized representation is obtained for further processing. In some examples, such a serialized representation is interoperable with JSON, while on-disk document representation may differ for performance reasons.

HRTDS 200 can allow multi-document transactions: multiple documents can be written in a single transaction. A transaction can be rolled back (or aborted) as a whole, while readers continue interacting with the data. Transactions may not involve SQL statements, but native language constructs such as disposables, privileged keywords (e.g., using) and, more generally, transaction contexts from which read-write operations must be performed.

In some examples, the data interface 214 to the DB engine 208 and/or DB 216 corresponds to simplified query system driven by native code, rather than a domain specific language (DSL). In the case of filter-free document fetch operations, the data interface 214 may take as input a command that does not correspond to a DSL query (e.g., even if the command's execution requires one or more such queries to be internally executed). In some examples, HRTDS 200 supports exact matches or range matches on secondary indices. HRTDS 200 can support geospatial queries through coarse grid-based coordinates.

In some examples, HRTDS 200 supports statistical measures and/or aggregation operations including counts, averages, minimums, maximums which can be effectuated on indexed properties (e.g., by a SQLite engine). Such operations can be used to obtain counts of documents and/or records. Complex operations can be accomplished by allowing the developer to retrieve a set of documents and/or records (e.g., using an access pattern such as those described above) and using a module that implements the specific calculation.

In some examples, HRTDS 200 enables partially or fully copying or replicating a DB (e.g., DB 216) to a separate distributed DB for additional access flexibility. Alternatively, a local DB (e.g., DB 216) can be interacted with directly from a cloud context using the same access pattern as a local host server (e.g., game server). For example, to read data, HRTDS 200 causes an entire DB (e.g., DB 216) to be downloaded to a temporary disk location and enables the data to be read data natively using a library. To write to the DB, HRTDS additionally updates locally stored DB data using a library, writes the updated data to the temporary disk location, and optionally uploads the modified DB to remote storage (e.g., cloud storage), creating a new version (see FIG. 5 for more details). This technique enables HRTDS 200 to support wide-scale migrations, fix data corruption, or implement novel features such as worlds that evolve autonomously (e.g., a lightweight function runs on a schedule to re-grow trees, replenish resources, and other features).

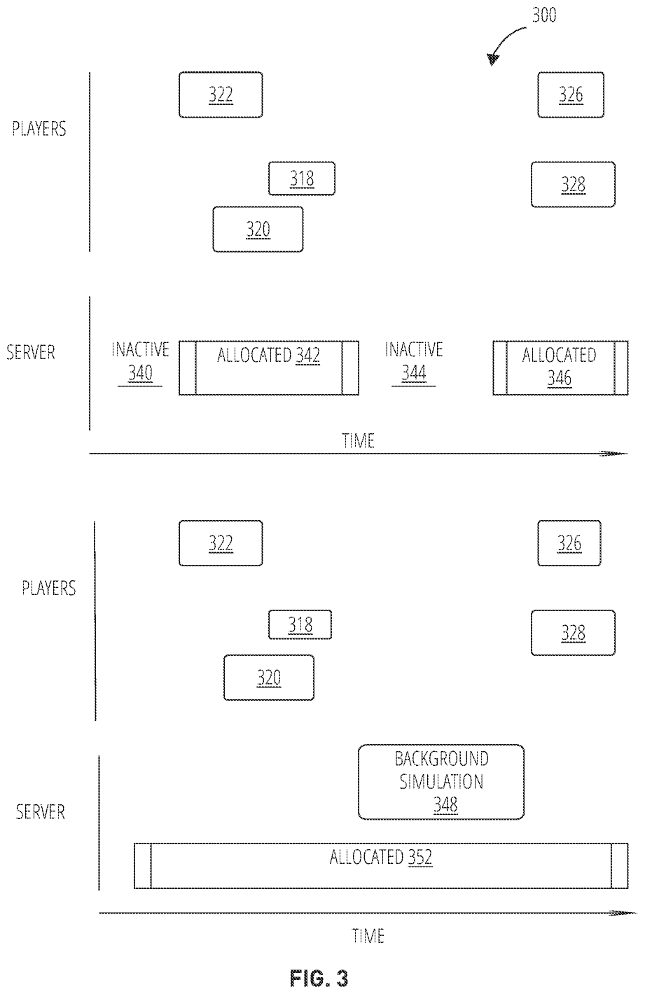

FIG. 3 is a diagrammatic representation 300 of server lifecycles, according to some examples. The top panel of FIG. 3 is an illustration of an example HRTDS 200 configuration in which a DB engine (e.g., DB engine 208) on a local host server 204 (such as a game server) is only active when a game is played, and inactive otherwise. The illustration represents periods of server activity and inactivity in the context of a particular world. Worlds can be long lived (e.g., the lifecycle can be measured in days, weeks, months and so forth). However, servers do not necessarily share a world's lifecycle. For example, the illustration includes inactive periods 340 or 344, during which server resources are not allocated, as well as periods 342 or 346 of server resource allocation (e.g., to the DB engine). The periods of server and/or DB engine activity or inactivity correspond to periods in which players (e.g., 318, 320, 322, 326, 328) enter or leave the world. Shutting down a DB engine and/or a server when the game is not being played (e.g., when there is no active player element) can result in significant cost savings. Restarting the DB engine and/or server can result in a slightly longer connection time and/or delay.

The bottom panel of FIG. 3 is an illustration of a HRTDS 200 configuration in which a DB engine (e.g., DB engine 208) on the local host server (e.g., 204), and/or the local server itself, is active throughout the entire lifecycle of a world (e.g., see element 352). Allowing the server and/or DB engine to be active without interruption can allow the running of a background simulation 348 even if the players (e.g., 318, 320, 322, 326, 328) are absent. On the other hand, allocating server resources without interruption can incur significant costs.

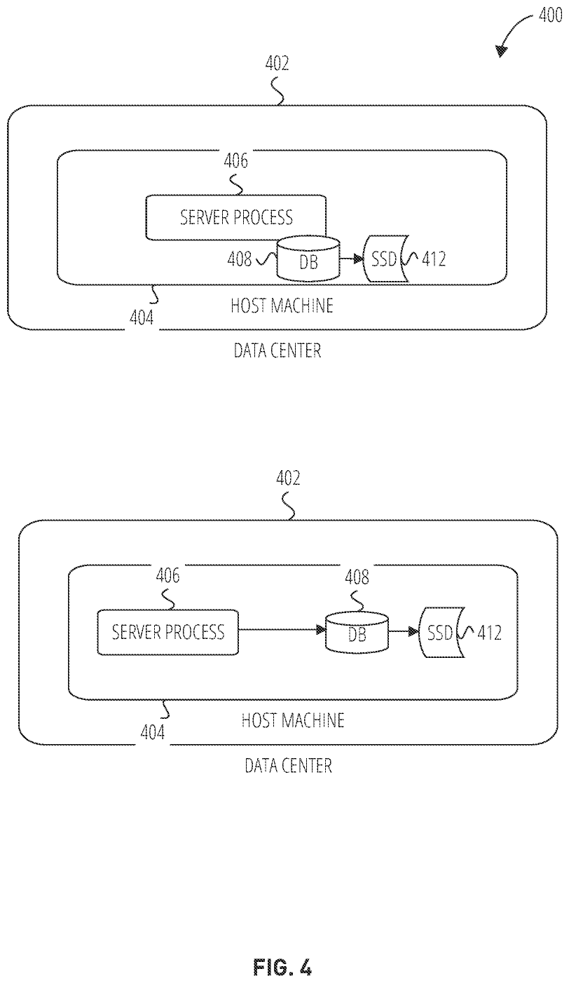

FIG. 4 is a diagrammatic representation 400 of data locality configurations, according to some examples, as implemented by HRTDS 200. As previously discussed in FIG. 2, HRTDS 200 enables a DB to be co-located with a host server. This scenario can be implemented using multiple configurations with the same data locality constraints, but different latency.

The top panel in FIG. 4 illustrates an embedded DB configuration used by HRTDS 200 in the context of a data center 402, a host machine 404 (e.g., corresponding to the host server 502), a server process 406, a DB 408 (e.g., corresponding to the DB 216), a solid-state drive (SSD) component 412, and so forth. In the example illustrated by the top panel of FIG. 4, DB 408 is co-located with the host machine 404 and embedded within the server process 406, where the server process 406 interacts directly with the filesystem (e.g., filesystem associated with SSD 412).

The bottom panel in FIG. 4 illustrates an alternative DB configuration used by HRTDS 200. DB 408 can run in a separate process from the server process 406. In this example, the server process 406 interacts with DB 408, while DB 408 interacts (e.g., via I/O operations) with the filesystem (e.g., associated with SSD 412). In some examples, this configuration results in additional latency (e.g., inter-process-communication (IPC) latency) on the order of 100 μs for a UNIX Domain Socket (UDS) (or a TCP socket). In some examples, the additional latency can be lower than 100 μs due to shared memory usage (e.g., if a DB supports local connection over shared memory). In some examples, additional latency can be increased due to the addition of data serialization operations and due to protocol overhead (e.g., HTTP, gRPC). In some examples, the additional latency can be in the 100 μs to 200 μs range.

In some examples, a HRTDS SDK (e.g., HRTDS SDK 504) is co-located with the host machine 404 (or host server 502), according to one of the above data locality configurations.

FIG. 5 is a diagrammatic illustration 500 of a DB download flow 520 and a DB upload flow 522, according to some examples.

In some examples, a DB download flow 520 includes a download of a remote DB with a given DB ID from cloud storage to the temporary storage of a local machine. In one example, as part of opening a DB on a host server, HRTDS 200 can perform a DB download from cloud storage to bring a DB copy to the local disk of a host server machine. The download from cloud storage adds variable initialization latency. Example DB download flow 520 involves a host server 502 (corresponding to the local machine), a HRTDS SDK 504 co-located with the host server 502, a HRTDS service 508 (e.g., a service API), cloud storage 510, and an example version of a DB instance, DB v3 512, among other components. The download process is asynchronous, as described in the following. DB download flow 520 includes a HRTDS SDK 504 request for a (signed) download URL, the request being made to the HRTDS service 508, the download URL request having a DB ID as parameter. The HRTDS service 508 interacts with the cloud storage 510 (e.g., using cloud backend 202) to obtain a signed URL, which is returned to HRTDS SDK 504. HRTDS SDK 504 uses the signed URL to download, from cloud storage 510, a snapshot of the DB with the corresponding DB ID (e.g., DB v3 512). Given a downloaded snapshot of the DB, the host server 502 can read data natively from the DB (e.g., using a library).

In the example above, data available in cloud storage (e.g., game world state data) transits directly between cloud storage 510 and a host server 502 (e.g., a game server, or any other HTTP client). Thus, there is a need to address authentication between the host server 502 and cloud storage 510. Authentication can be addressed by means of one or more signed URLs, as mentioned above. In some examples, authentication can be addressed through anonymous access to buckets. In some examples, authentication can be addressed via authentication federation: allowing a universal authentication server (UAS) token (e.g., a JSON web token (JWT)) to be a recognized OpenID Connect (OIDC) provider for cloud storage 510, and give the proper permissions on the bucket access control list (ACL).

Given a DB ID, a DB or DB snapshot (e.g. DB v3 512, DB 216, etc.) can be downloaded from remote storage (e.g., central storage, cloud storage 510) to a host server (e.g., host server 502), it can be updated or mutated by an independent actor (e.g., the host server 502), and then re-uploaded to remote storage to form a new version of the DB. The DB can be versioned at consistent points in time, via a read transaction that makes one or more copies of the DB. Copies can be uploaded to cloud storage 510, thereby creating new DB versions. The creation of new DB versions responsive to DB uploads allows rollback functionality for the developer and/or user's benefit. Previous versions are also available for download. This copy and/or upload process, similarly to the download process, is asynchronous. In some examples, DB backups and/or copies enable finer granularity at the per-completed-transaction level, recording and/or backing up one or more completed transactions (e.g., for instance allowing for providing a backup audit trail, or to mitigate a delayed backup or backup too long after a particular event occurred). Each copy of a DB is accumulated as a DB version in the bucket in which a DB and its versions are stored. In some examples, older DB versions (e.g., versions created before a predetermined time point, the first N versions for a given constant N, all versions but the most recent M versions for a given constant M, etc.) are moved to lower cost tiers and eventually deleted to limit the storage costs.

A developer can explicitly cause a new DB version to be created (e.g., manually, automatically after a meaningful event in the world is detected by the host server 502, etc.) or configure the HRTDS 200 to create new versions at regular intervals. In some examples, HRTDS 200 enables restorations of previous DB versions. Example restoration requests can be triggered as a gameplay feature, or for customer support purposes, using admin privileges (e.g., UDash, CLI). In some examples, the HRTDS 200 download and/or upload flows do not allow for eventual consistency. Uploads of new versions add latency, but they are non-blocking, except in the case of server termination (e.g., server resources cannot be liberated until the upload completes).

Example DB upload flow 522 includes host server 502, HRTDS SDK 504, a working DB 514, a backup 516, HRTDS service 508, cloud storage 510, and DB v4 518, among other components. In some examples, working DB 514 corresponds to a DB or DB snapshot being read and/or updated by the host server 502. A version of working DB 514 (e.g., a modified version) can be stored (e.g., by HRTDS SDK 504), to the temporary storage of the host server machine, for example being backed up using backup 516. HRTDS SDK 504 requests a (signed) upload URL from HRTDS service 508, which requests and/or obtains a signed URL from cloud storage 510. HRTDS service 508 returns the signed URL to HRTDS SDK 504. HRTDS SDK 504 uploads backup 516 to cloud storage, resulting in the creation of DB v4 518 residing in cloud storage 510.

Avoiding and/or Detecting Conflicts

In some examples, multiple agents (e.g., host servers) can download a DB from remote storage (e.g., cloud storage), modify the DB, and attempt to commit or upload the results back to remote storage. HRTDS 200 can implement one or more mechanisms for avoiding and/or detecting and/or addressing conflicts addressing from such situations.

In some examples, HRTDS 200 can use an optimistic concurrency control (OCC) approach that assumes such conflicts are rare and accidental. A DB (e.g., DB v3 512, DB 216, etc.) is downloaded and annotated with a content signature or equivalent fingerprint (e.g., a GCS generation number, ETag, etc.) Upon uploading a new DB version, the host server 502 (e.g., the HTTP client) transmits this original signature alongside the data. Before the cloud storage (e.g., corresponding to cloud backend 202) accepts the new version, HRTDS 200 validates that the current DB version in storage has a fingerprint or signature matching the original fingerprint or signature. If so, the upload is completed. If not, the upload is refused and the host server is informed of the conflict. A host server 502 receiving information about a conflict can: a) download the latest version of the target DB, re-apply its changes (e.g., merge) on top of it and reupload the modified DB version; b) force its version to become current, for example by omitting the signature during upload of its DB version; or c) abort the DB upload and lose the respective changes.

In some examples, HRTDS 200 can use a generation ID of DB objects in a bucket to enforce optimistic concurrency with multiple writers. A generation ID uniquely identifies the version of an object, such as a DB object. Cloud storage solutions (e.g., GCS) can update a generation ID associated with a DB each time it is written to or updated. Upon the host server 502 uploading or downloading a DB using signed URLs, the cloud storage (e.g., the cloud backend 202) returns a header exposed by HRTDS SDK 504 to a host server 502. The header indicates the generation ID associated with the most recent stored version of the DB, and allows the host server 502 to specify a generation ID in subsequent uploads. In some examples, generating a signed upload URL can take an input an optional generation ID in order to incorporate the header above into the signed URL. When HRTDS service 508 sends an upload request using the signed URL incorporating this header to the cloud storage 510, a response from cloud storage 510 can include a status code indicating whether the DB to be uploaded already has a newer version residing in cloud storage 510. The status code is computed based on comparing the generation ID in the header with the most recent generation ID associated with the most recently stored DB version (e.g., stored in cloud storage). If the generation IDs match, the response from cloud storage 510 can include a success status code, indicating the upload operation was successful. If the generation IDs do not match, the response from cloud storage 510 includes a failure status code that indicates that an independently modified DB version has been uploaded to cloud storage during the period of time between downloading the DB version local to host server 502 and the time of attempted upload of the modified DB version. If so, HRTDS 200 can re-generate or modify a signed upload URL to omit any generation ID. The use of such a signed upload URL has the effect of writing a new version of the DB object regardless of its current version residing in cloud storage. As an alternative, HRTDS SDK 504 co-located with host server 502 can download the latest DB version and/or obtain the latest generation ID, and then retry using a signed URL specifying the respective latest generation ID. (e.g., re-try the optimistically concurrent upload).

In some examples, HRTDS 200 uses an explicit checkout with concurrent access prevention approach, as detailed below. First, a host server 502 can attempt to check out a DB (e.g., DB v3 512, etc.) from remote storage (e.g., HRTDS SDK 504 at host server 502 can directly attempt a check out from cloud storage 510, or can first interact with the HRTDS service 508 in a manner similar to that described above). If the respective DB is already checked out, the check-out operation will fail. The host server 502 will be informed of the failure (e.g., by receiving a failure or error status code). The failure indicates that the DB can still be downloaded, however the data might be stale as the failed checkout indicates another actor (e.g., another host server or game server) is currently reading and/or updating the data. The host server 502 can a) wait for a predetermined period of time and re-attempt to check out the DB (e.g., implement a retry loop), b) forgo the checkout operation, and/or download the (potentially stale) version, or c) force a checkout of the DB, for example overriding a DB lock that prevents check out. In the explicit checkout option described herein, a host server 502 that uploads a new DB version must establish that it has previously checked out the DB as described above. Establishing the previous checkout can be done by a) using the authentication information alone, an option that assumes that the host server is not expected to conflict with itself; b) appending to the upload request an indicator that a lock to the DB is held by the host server (e.g., using a nonce value), or c) staging the new version of the DB as a result of the check-out operation and using the staged DB version as the target of the upload request. In some example, DB locks require attribution, to indicate for example that a check-out operation and check-in operation are performed by the same entity that has the lock. In some examples, attribution will be based on server information and take into account whether servers have unique identities. In some examples, attribution will take into account different sessions of the same server, for example to avoid same-server concurrency issues (e.g., double allocation of a game server running on the same physical machine). In some examples, HRTDS 200 will need to use a strategy for preventing lock staleness, such as time-outs, keep-alive/heartbeat operations, revival operations, auto-revocation operations, and so forth. In some examples, servers will need to communicate whether the check-out intention is related to a “Read only” or a “Read-and-write” operation. Checkouts can be held by specific users or tracked in workspaces consisting, for example, of a computer name and/or directory path.

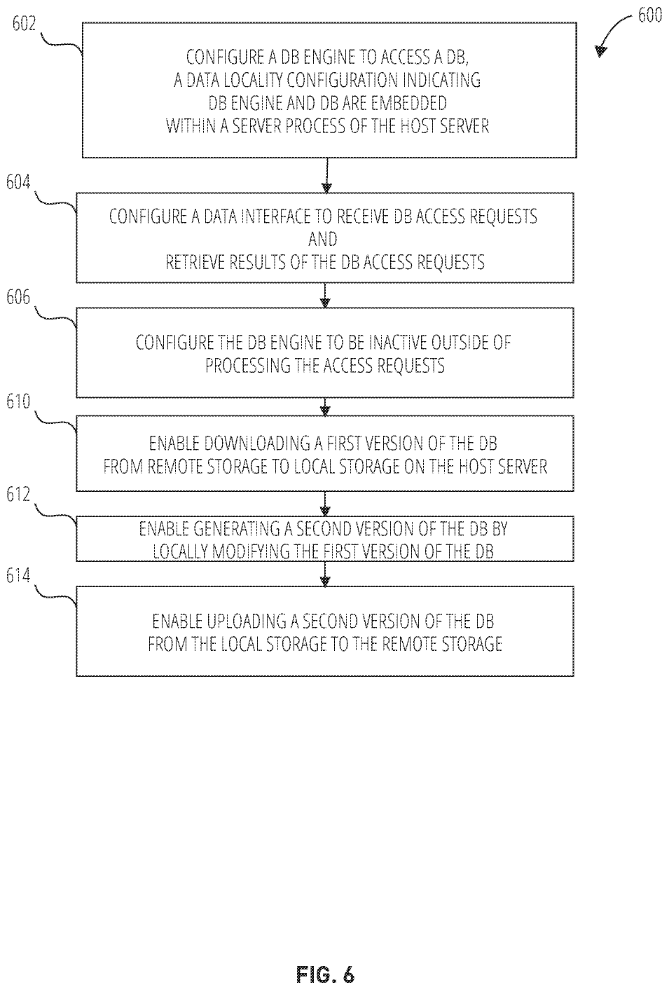

FIG. 6 illustrates an example method 600, as implemented by HRTDS 200. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

At operation 602, HRTDS 200 configures a DB engine 208 to access a DB 216, the DB engine 208 and the DB 216 being configured according to a data locality configuration of a plurality of data locality configurations, the data locality configuration indicating the DB engine 208 and the DB 216 are local to a host server 204, and are further embedded within a server process of the host server 204.

At operation 604, HRTDS 200 configures a data interface to receive access requests associated with DB 216, and to retrieve results of the DB access requests. At operation 606, HRTDS 200 configures the DB engine 208 to be inactive outside of processing the access requests. The DB engine 208 becomes or remains live or active (e.g., host 204 owns the respective DB live runtime) during processing one or more of the access requests.

At operation 610, HRTDS 200 configures a software development kit (SDK) 504 to enable downloading a first version of the DB 216 from remote storage (e.g., cloud storage 510) to local storage on the host server 204. At operation 612, HRTDS 200 configures the HRTDS SDK 504 to enable generating a second version of the DB 216 by modifying the first version of the DB 216 at the local host server 204. At operation 614, HRTDS configures the HRTDS SDK 504 to enable uploading the second version of the DB 216 from the local storage on the host server 204 to the remote storage (cloud storage 510).

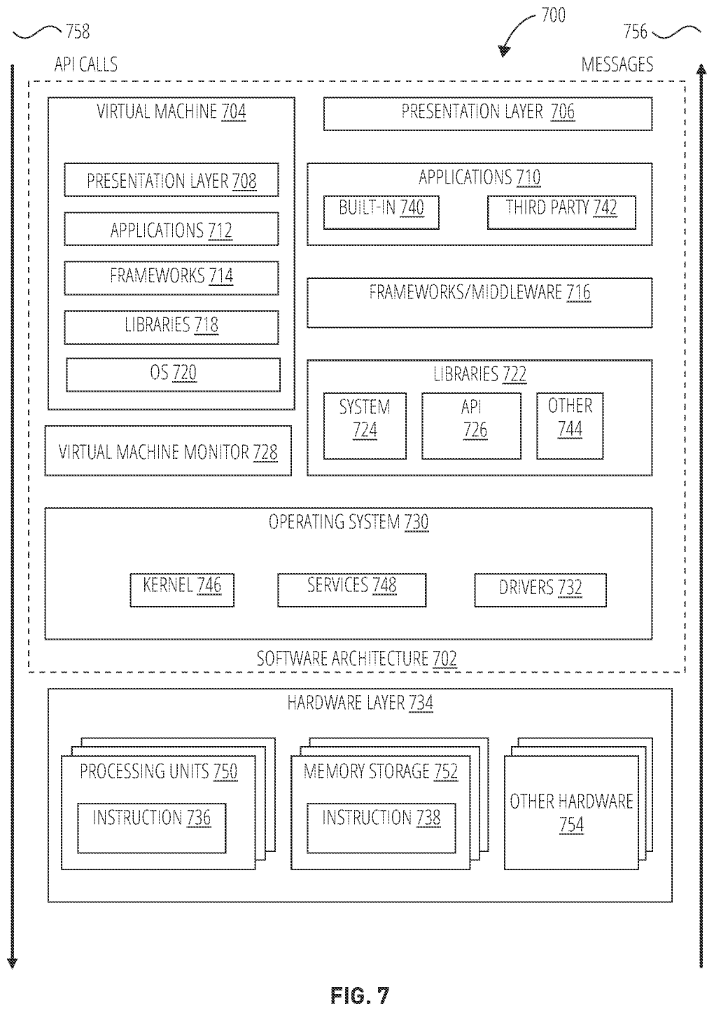

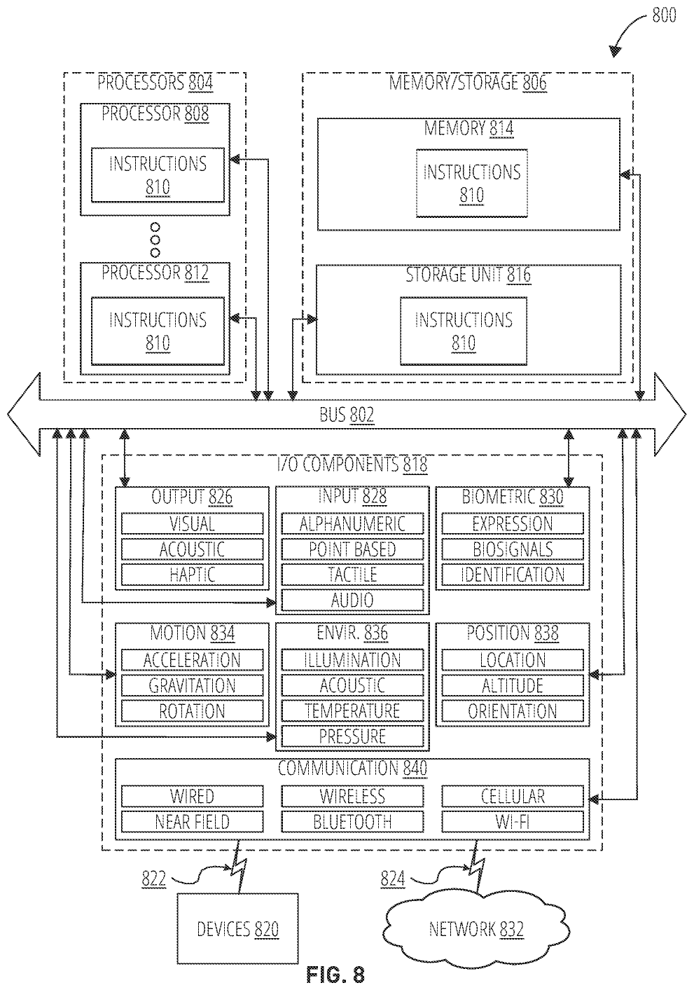

FIG. 7 is a block diagram illustrating an example of a software architecture 702 that may be installed on a machine, according to some example embodiments. FIG. 7 is merely a non-limiting example of software architecture, and it will be appreciated that many other architectures may be implemented to facilitate the functionality described herein. The software architecture 702 may be executing on hardware such as a machine 800 of FIG. 8 that includes, among other things, processors 804, memory/storage 806, and input/output (I/O) components 1518. A representative hardware layer 734 is illustrated and can represent, for example, the machine of FIG. 8. The representative hardware layer 734 comprises one or more processing units 750 having associated executable instructions 736. The executable instructions 736 represent the executable instructions of the software architecture 702. The hardware layer 734 also includes memory or memory storage 752, which also have the executable instructions 738. The hardware layer 734 may also comprise other hardware 754, which represents any other hardware of the hardware layer 734 such as the other hardware illustrated as part of the machine 800.

In the example architecture of FIG. 7, the software architecture 702 may be conceptualized as a stack of layers, where each layer provides particular functionality. For example, the software architecture 702 may include layers such as an operating system 730, libraries 718, frameworks/middleware 716, applications 710, and a presentation layer 708. Operationally, the applications 710 or other components within the layers may invoke API calls 758 through the software stack and receive a response, returned values, and so forth (illustrated as messages 756) in response to the API calls 758. The layers illustrated are representative in nature, and not all software architectures have all layers. For example, some mobile or special-purpose operating systems may not provide a frameworks/middleware 716 layer, while others may provide such a layer. Other software architectures may include additional or different layers.

The operating system 730 may manage hardware resources and provide common services. The operating system 730 may include, for example, a kernel 746, services 748, and drivers 732. The kernel 746 may act as an abstraction layer between the hardware and the other software layers. For example, the kernel 746 may be responsible for memory management, processor management (e.g., scheduling), component management, networking, security settings, and so on. The services 748 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 718 may provide a common infrastructure that may be utilized by the applications 710 and/or other components and/or layers. The libraries 718 typically provide functionality that allows other software modules to perform tasks in an easier fashion than by interfacing directly with the underlying operating system 730 functionality (e.g., kernel 746, services 748 or drivers 732). The libraries 718 may include system libraries 718 (e.g., C standard library) that may provide functions such as memory allocation functions, string manipulation functions, mathematic functions, and the like. In addition, the libraries 718 may include API libraries 1028 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 718 may also include a wide variety of other libraries 722 to provide many other APIs to the applications 710 or applications 712 and other software components/modules.

The frameworks 714 (also sometimes referred to as middleware) may provide a higher-level common infrastructure that may be utilized by the applications 710 or other software components/modules. For example, the frameworks 714 may provide various graphical user interface functions, high-level resource management, high-level location services, and so forth. The frameworks 714 may provide a broad spectrum of other APIs that may be utilized by the applications 710 and/or other software components/modules, some of which may be specific to a particular operating system or platform.

The applications 710 include built-in applications 740 and/or third-party applications 742. Examples of representative built-in applications 740 may include, but are not limited to, a home application, a contacts application, a browser application, a book reader application, a location application, a media application, a messaging application, or a game application.

The third-party applications 742 may include any of the built-in applications 740 as well as a broad assortment of other applications. In a specific example, the third-party applications 742 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 742 may invoke the API calls 758 provided by the mobile operating system such as the operating system 730 to facilitate functionality described herein.

The applications 710 may utilize built-in operating system functions, libraries (e.g., system libraries 724, API libraries 726, and other libraries), or frameworks/middleware 716 to create user interfaces to interact with users of the system. Alternatively, or additionally, in some systems, interactions with a user may occur through a presentation layer, such as the presentation layer 708. In these systems, the application/module “logic” can be separated from the aspects of the application/module that interact with the user.

Some software architectures utilize virtual machines. In the example of FIG. 7, this is illustrated by a virtual machine 704. The virtual machine 704 creates a software environment where applications/modules can execute as if they were executing on a hardware machine. The virtual machine 704 is hosted by a host operating system (e.g., the operating system 730) and typically, although not always, has a virtual machine monitor 728, which manages the operation of the virtual machine 904 as well as the interface with the host operating system (e.g., the operating system 730). A software architecture executes within the virtual machine 704, such as an operating system 730, libraries 718, frameworks/middleware 716, applications 712, or a presentation layer 708. These layers of software architecture executing within the virtual machine 704 can be the same as corresponding layers previously described or may be different.

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 810 (e.g., software, a program, an application, an applet, an app, or other executable code) for causing the machine 800 to perform any one or more of the methodologies discussed herein may be executed. As such, the instructions 810 may be used to implement modules or components described herein. The instructions 810 transform the general, non-programmed machine 800 into a particular machine 800 to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), other smart devices, a web appliance, a network router, a network switch, a network bridge, or any machine capable of executing the instructions 810, sequentially or otherwise, that specify actions to be taken by machine 800. Further, while only a single machine 800 is illustrated, the term “machine” shall also be taken to include a collection of machines that individually or jointly execute the instructions 810 to perform any one or more of the methodologies discussed herein.

The machine 800 may include processors 804, memory/storage 806, and I/O components 818, which may be configured to communicate with each other such as via a bus 802. The memory/storage 806 may include a memory 814, such as a main memory, or other memory storage, and a storage unit 816, both accessible to the processors 804 such as via the bus 802. The storage unit 816 and memory 814 store the instructions 810 embodying any one or more of the methodologies or functions described herein. The instructions 810 may also reside, completely or partially, within the memory 814 within the storage unit 816, within at least one of the processors 804 (e.g., within the processor's cache memory), or any suitable combination thereof, during execution thereof by the machine 800. Accordingly, the memory 814 the storage unit 816, and the memory of processors 804 are examples of machine-readable media.

The I/O components 818 may include a wide variety of components to receive input, provide output, produce output, transmit information, exchange information, capture measurements, and so on. The specific I/O components 818 that are included in a particular machine 800 will depend on the type of machine. For example, portable machines such as mobile phones will likely include a touch input device or other such input mechanisms, while a headless server machine will likely not include such a touch input device. It will be appreciated that the I/O components 818 may include many other components that are not shown in FIG. 8. The U/O components 818 are grouped according to functionality merely for simplifying the following discussion and the grouping is in no way limiting. In various example embodiments, the I/O components 818 may include output components 826 and input components 828. The output components 826 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 828 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 818 may include biometric components 830, motion components 834, environmental environment components 836, or position components 838 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 834 may include acceleration sensor components (e.g., accelerometer), gravitation sensor components, rotation sensor components (e.g., gyroscope), and so forth. The environment components 836 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 838 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818 may include communication components 840 operable to couple the machine 800 to a network 832 or devices 820 via coupling 822 and coupling 824 respectively. For example, the communication components 840 may include a network interface component or other suitable device to interface with the network 832. In further examples, communication components 840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 820 may be another machine or any of a wide variety of peripheral devices (e.g., a peripheral device coupled via a Universal Serial Bus (USB)).

Moreover, the communication components 840 may detect identifiers or include components operable to detect identifiers. For example, the communication components 840 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840, such as, location via Internet Protocol (IP) geo-location, location via Wi-Fi® signal triangulation, location via detecting a NFC beacon signal that may indicate a particular location, and so forth.

### Examples

Example 1 is a system, comprising: at least one processor; at least one memory component storing instructions that, when executed by the at least one processor, cause the at least one processor to perform operations comprising: configuring a database (DB) engine to access a DB, the DB engine and the DB being configured based on a data locality configuration of a plurality of data locality configurations, the data locality configuration being associated with a first server, the DB engine being configured to process access requests and be inactive outside of processing the access requests; configuring a data interface to receive access requests associated with the DB and retrieve results of the access requests associated with the DB; and configuring a software module to enable downloading of a first version of the DB from remote storage to local storage associated with the first server, and enable uploading of a second version of the DB from the local storage to the remote storage.

In Example 2, the subject matter of Example 1 includes, wherein the data locality configuration specifies that the DB engine and the DB are embedded within a server process of the first server.

In Example 3, the subject matter of Examples 1-2 includes, wherein: the access requests associated with the DB comprise one of at least a read access request and a write access request; the data interface is configured to provide, to the first server, read access to the DB and write access to the DB; and the data interface is configured to provide, to a second server, read access to the DB and disallow, to the second server, write access to the DB.

In Example 4, the subject matter of Example 3 includes, configured to transmit a notification to the second server responsive to detecting a change to the DB, the second server being a subscriber server configured to receive change notifications.

In Example 5, the subject matter of Examples 1-4 includes, wherein the DB is associated with metadata comprising one or more of a DB ID, a DB version number, a file path associated with the first server, or a bucket ID corresponding to a remote storage bucket.

In Example 6, the subject matter of Example 5 includes, wherein downloading the first version of the DB from the remote storage to the first server comprises: transmitting a request for a signed download URL to a service API, the request including the DB ID, the service API communicating with a remote storage backend associated with the remote storage; receiving, from the service API, the signed download URL, the signed download URL specifying a location of a current version of the DB at the remote storage; and using the signed download URL, retrieving from the remote storage the current version of the DB as the first version of the DB.

In Example 7, the subject matter of Example 6 includes, wherein uploading the second version of the DB from the local storage associated with the first server to the remote storage comprises: generating the second version of the DB by modifying the first version of the DB; storing the second version of the DB in temporary storage of the first server; transmitting a request for a signed upload URL to the service API that communicates with the remote storage backend, the request including the DB ID; receiving, from the service API, a signed upload URL specifying an upload location at the remote storage; and using the signed upload URL, uploading the second version of the DB to the upload location.

In Example 8, the subject matter of Example 7 includes, wherein: the received signed download URL comprises a generation ID corresponding to the current DB version stored at the remote storage; the signed upload URL is updated to comprise the generation ID; and using the signed upload URL to upload the second version of the DB further comprises receiving a status code based on a comparison between the generation ID and a most recent generation ID of a most recent DB version stored at the remote storage.

In Example 9, the subject matter of Example 8 includes, wherein: the status code is a failure code indicating that the generation ID does not match the current generation ID of the most recent DB version stored at the remote storage; and wherein the operations further comprise: generating a second signed upload URL by removing the generation ID from the signed upload URL; and using the second signed upload URL, uploading the second version of the DB to the upload location.

In Example 10, the subject matter of Examples 8-9 includes, wherein: the status code is a success code indicating the generation ID matches the current generation ID; and wherein the operations further comprise: transmitting a request for a second signed download URL to the service API, the request including the DB ID; and receiving, from the service API, the second signed download URL, the signed download URL comprising a second generation ID generated, at the remote storage, for the second version of the DB.

Example 11 is at least one non-transitory computer-readable (or machine-readable) medium including instructions that, when executed by processing circuitry, cause the processing circuitry to perform operations to implement of any of Examples 1-10.

Example 12 is an apparatus comprising means to implement any of Examples 1-10.

Example 13 is a computer-implemented method to implement of any of Examples 1-10.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

“SHADER” in this context refers to a program that runs on a GPU, a CPU, a TPU and so forth. In the following, a non-exclusive listing of types of shaders is offered. Shader programs may be part of a graphics pipeline. Shaders may also be compute shaders or programs that perform calculations on a CPU or a GPU (e.g., outside of a graphics pipeline, etc.). Shaders may perform calculations that determine pixel properties (e.g., pixel colors). Shaders may refer to ray tracing shaders that perform calculations related to ray tracing. A shader object may (e.g., an instance of a shader class) may be a wrapper for shader programs and other information. A shader asset may refer to a shader file (or a “.shader” extension file), which may define a shader object.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system, comprising:
at least one processor;
at least one memory component storing instructions that, when executed by the at least one processor, cause the at least one processor to perform operations comprising:
configuring a database (DB) engine to access a DB, the DB engine and the DB being configured based on a data locality configuration of a plurality of data locality configurations, the data locality configuration being associated with a first server, the DB engine being configured to process access requests and be inactive outside of processing the access requests;
configuring a data interface to receive access requests associated with the DB and retrieve results of the access requests associated with the DB; and
configuring a software module to enable downloading of a first version of the DB from remote storage to local storage associated with the first server, and enable uploading of a second version of the DB from the local storage to the remote storage.

2. The system of claim 1, wherein the data locality configuration specifies that the DB engine and the DB are embedded within a server process of the first server.

3. The system of claim 1, wherein:
the access requests associated with the DB comprise one of at least a read access request and a write access request;
the data interface is configured to provide, to the first server, read access to the DB and write access to the DB; and
the data interface is configured to provide, to a second server, read access to the DB and disallow, to the second server, write access to the DB.

4. The system of claim 3, further configured to transmit a notification to the second server responsive to detecting a change to the DB, the second server being a subscriber server configured to receive change notifications.

5. The system of claim 1, wherein the DB is associated with metadata comprising one or more of a DB ID, a DB version number, a file path associated with the first server, or a bucket ID corresponding to a remote storage bucket.

6. The system of claim 5, wherein downloading the first version of the DB from the remote storage to the first server comprises:
transmitting a request for a signed download URL to a service API, the request including the DB ID, the service API communicating with a remote storage backend associated with the remote storage;
receiving, from the service API, the signed download URL, the signed download URL specifying a location of a current version of the DB at the remote storage; and
using the signed download URL, retrieving from the remote storage the current version of the DB as the first version of the DB.

7. The system of claim 6, wherein uploading the second version of the DB from the local storage associated with the first server to the remote storage comprises:
generating the second version of the DB by modifying the first version of the DB;
storing the second version of the DB in temporary storage of the first server;
transmitting a request for a signed upload URL to the service API that communicates with the remote storage backend, the request including the DB ID;
receiving, from the service API, a signed upload URL specifying an upload location at the remote storage; and
using the signed upload URL, uploading the second version of the DB to the upload location.

8. The system of claim 7, wherein:
the received signed download URL comprises a generation ID corresponding to the current DB version stored at the remote storage;
the signed upload URL is updated to comprise the generation ID; and
using the signed upload URL to upload the second version of the DB further comprises receiving a status code based on a comparison between the generation ID and a most recent generation ID of a most recent DB version stored at the remote storage.

9. The system of claim 8, wherein:
the status code is a failure code indicating that the generation ID does not match the current generation ID of the most recent DB version stored at the remote storage; and
wherein the operations further comprise:
generating a second signed upload URL by removing the generation ID from the signed upload URL; and
using the second signed upload URL, uploading the second version of the DB to the upload location.

10. The system of claim 8, wherein:
the status code is a success code indicating the generation ID matches the current generation ID; and wherein the operations further comprise:
transmitting a request for a second signed download URL to the service API, the request including the DB ID; and
receiving, from the service API, the second signed download URL, the signed download URL comprising a second generation ID generated, at the remote storage, for the second version of the DB.

11. A computer-implemented method, comprising:
configuring a database (DB) engine to access a DB, the DB engine and the DB being configured based on a data locality configuration of a plurality of data locality configurations, the data locality being associated with a first server, the DB engine being configured to process access requests and be inactive outside of processing the access requests;
configuring a data interface to receive access requests associated with the DB and retrieve results of the access requests associated with the DB; and
configuring a software module to:
enable downloading of a first version of the DB from remote storage to local storage associated with the first server; and
enable uploading of a second version of the DB from the local storage to the remote storage.

12. The computer-implemented method of claim 11,
wherein the data locality configuration specifies that the DB engine and the DB are embedded within a server process of the first server.

13. The computer-implemented method of claim 11, wherein:
the access requests associated with the DB comprise one of at least a read access request and a write access request;
the data interface is configured to provide, to the first server, read access to the DB and write access to the DB; and
the data interface is configured to provide, to a second server, read access to the DB and disallow, to the second server, write access to the DB.

14. The computer-implemented method of claim 13, further comprising transmitting a notification to the second server responsive to detecting a change to the DB, the second server being a subscriber server configured to receive change notifications.

15. The computer-implemented method of claim 11, wherein the DB is associated with metadata comprising one or more of a DB ID, a DB version number, a file path associated with the first server, or a bucket ID corresponding to a remote storage bucket.

16. The computer-implemented method of claim 15, wherein downloading the first version of the DB from the remote storage to the first server comprises:
transmitting a request for a signed download URL to a service API, the request including the DB ID, the service API communicating with a remote storage backend associated with the remote storage;
receiving, from the service API, the signed download URL, the signed download URL specifying a location of a current version of the DB at the remote storage; and
using the signed download URL, retrieving from the remote storage the current version of the DB as the first version of the DB.

17. The computer-implemented method of claim 16, wherein uploading the second version of the DB from the local storage associated with the first server to the remote storage comprises:
generating the second version of the DB by modifying the first version of the DB;
storing the second version of the DB in temporary storage of the first server;
transmitting a request for a signed upload URL to the service API that communicates with the remote storage backend, the request including the DB ID;
receiving, from the service API, a signed upload URL specifying an upload location at the remote storage; and
using the signed upload URL, uploading the second version of the DB to the upload location.

18. The computer-implemented method of claim 17, wherein the received signed download URL comprises a generation ID corresponding to the current DB version stored at the remote storage;
the signed upload URL is updated to comprise the generation ID; and
using the signed upload URL to upload the second version of the DB further comprises receiving a status code based on a comparison between the generation ID and a most recent generation ID of a most recent DB version stored at the remote storage.

19. The computer-implemented method of claim 18, wherein
the status code is a failure code indicating that the generation ID does not match the current generation ID of the most recent DB version stored at the remote storage; and
wherein the method further comprises:
generating a second signed upload URL by removing the generation ID from the signed upload URL; and
using the second signed upload URL, uploading the second version of the DB to the upload location.

20. A non-transitory computer-readable storage medium, the non-transitory computer-readable storage medium including instructions that, when executed by one or more computer processors, cause the one or more computer processors to perform operations, the operations comprising:
configure a database (DB) engine to access a DB, the DB engine and the DB being configured based on a data locality configuration of a plurality of data locality configurations, the data locality configuration being associated with a first server, the DB engine being configured to process access requests and be inactive outside of processing the access requests;
configure a data interface to receive access requests associated with the DB and retrieve results of the access requests associated with the DB; and
configure a software module to:
enable downloading of a first version of the DB from remote storage to local storage associated with the first server; and
enable uploading of a second version of the DB from the local storage to the remote storage.
